(19) United States
(12) Patent Application Publication
(10) Pub. No.: US 2026/0312913 A1
(43) Pub. Date: Oct. 8, 2026

(54) ADD BOTH TX AND RX FLIT SEQUENCE NUMBERS INTO FLIT HEADER OF REPLAYABLE FLITS

(71) Applicants: Advanced Micro Devices, Inc., Santa Clara, CA (US); ATI Technologies ULC, Markham (CA)

(72) Inventors: Michael Tresidder, Willow City, TX (US); Shaofeng An, Ontario (CA); YanFeng Wang, Ontario (CA); David Alan Brown, Ontario (CA); Mingyu Liu, Austin, TX (US)

(73) Assignees: Advanced Micro Devices, Inc., Santa Clara, CA (US); ATI Technologies ULC, Markham (CA)

(21) Appl. No.: 19/396,115

(22) Filed: Nov. 20, 2025

Related U.S. Application Data
(60) Provisional application No. 63/783,733, filed on Apr. 4, 2025.

(51) Int. Cl. H04L 47/34

(52) U.S. Cl. CPC H04L 47/34

(57) ABSTRACT

Systems and devices for packing one or more sequence numbers into datagrams for transmission to a link partner over an interconnect fabric, the link partners including a transmitter in communication with a receiver for data transmission over the interconnect link, each of the transmitter and the receiver including at least one circuit. The at least one circuit packages a header and a data payload into data packets for transmission to the other of the transmitter and the receiver. Responsive to a request from the transmitter or the receiver, the at least one circuit of the transmitter or the receiver encodes a first sequence number and a second sequence number into the header of the data packet for transmission to the other of the transmitter or the receiver. The first sequence number may be a transmitter sequence number, and the second sequence number may be a receiver sequence number.

### CROSS-REFERENCE TO RELATED APPLICATIONS

The present application claims priority to and benefit of U.S. Provisional Patent Application No. 63/783,733, filed Apr. 4, 2025, and entitled “ADD BOTH TX AND RX FLIT SEQUENCE NUMBERS INTO FLIT HEADER OF REPLAYABLE FLITS,” the entirety of which is herein incorporated by reference.

### BACKGROUND

Accelerators are computing systems such as, for example, processing nodes that are commonly used in data centers to perform a wide range of processing tasks. These processing tasks can include, for example, computations, deep learning training, model inferencing, high performance computing, data analytics, virtualization, and other applications. Many such processing tasks require real-time or near real-time results, which may be achieved by utilizing multiple processing nodes working together through high-speed data communication and resource sharing to perform common tasks. Accordingly, providing high-speed, low-latency communications over an interconnect fabric between nodes plays a critical role in capitalizing on the full potential of these systems.

### BRIEF DESCRIPTION OF THE DRAWINGS

FIG. 1 illustrates a block diagram of an exemplary system, according to some embodiments.

FIG. 2 illustrates a diagram of an exemplary system, according to some embodiments.

FIG. 3 illustrates a block diagram of an exemplary system, according to some embodiments.

FIG. 4 is a block diagram of an exemplary system configured to implement the techniques described herein, according to some embodiments.

FIG. 5 illustrates an example diagram of a portion of an exemplary communication system for implementing the TX and RX flit sequence numbers into the flit header of data flits, according to some embodiments.

FIG. 6 illustrates an exemplary data transmission of flits between a transmitter and receiver of link partners, according to some embodiments.

FIG. 7 illustrates an exemplary datagram for carrying the TX and RX sequence numbers in data flits, according to some embodiments.

FIG. 8 is a flow diagram of a method for data transmission of datagrams between link partners over an interconnect link, according to some embodiments.

### DETAILED DESCRIPTION

Described herein are various examples of systems and methods for supporting replay for data transmissions over an interconnect link in accordance with a protocol for enabling high-speed, low-latency communication between link partners, which may in some embodiments be implemented by revising headers of datagrams (e.g., data packets, data flits, etc.) and adding both transmitter (TX) and receiver (RX) sequence numbers into the header. The link partners may in some embodiments be chiplets, processors, accelerators, nodes, host computing devices, servers, or any combinations thereof, among other circuits or devices. The datagrams may in some embodiments be flow control units (flits), and the TX and RX sequence numbers may be added to the flit header.

Some conventional systems may transmit flits having a designated sequence number in the flit header to specify their order, the sequence number being the TX sequence number of the transmitted flit or the RX sequence number of a previously received flit for acknowledgment. In contrast, modifying the header of the datagram in accordance with the techniques described herein so as to include both TX and RX sequence numbers may enable a TX to simultaneously provide a TX sequence number of the transmitted data payload and a RX sequence number to acknowledge received flits or to request replay of flits due to an error in the received flits. For example, a data flit sent by a TX may include both a TX flit sequence number of the data payload and an RX flit sequence number to request replay of a data flit received during a previous clock cycle due to a cyclic redundancy check (CRC) error associated with the previously received data flit.

Revising the headers may in some embodiments include sending the TX sequence number when sending acknowledgement (ACK) or replay request (NAK) datagrams to a RX, where traditionally only the RX sequence number is sent in the header. The modified headers may in some embodiments include the full TX sequence number. The TX sending the full form of the TX sequence number may allow for modification of the functionalities of at least one of the TX and the RX. In some embodiments, the modification to the RX functionality can include removing a TX sequence number inference. In some embodiments, the modification to the TX functionality can include removal of the TX/RX sequence number arbitrations. The header may in some embodiments be modified so as to include a partial TX sequence number. Sending the partial TX sequence number may include implementing one or more additional logical functions on the link partner's RX side to provide increased tolerance of ambiguity, which will be further described herein.

In some computing systems, accelerators can include multiple processing units, each of which can be broadly utilized to perform various high performance computing and machine learning processing tasks including, for example and without limitation, deep learning training, autonomous vehicle operations, data analytics, model inferencing, scientific simulations, financial modeling, climate modeling, graphics rendering, data mining, among other applications. In some computing systems, multiple accelerators can be broadly utilized to perform these various high performance computing and machine learning processing tasks. The rising demand for accelerators for use in these and other types of applications (e.g., AI applications) is also driving the demand for faster communications over interconnect links for data transmission and resource sharing functionality. For example, two nodes in a data center may be connected to each other through an interconnect fabric that includes communicating Ethernet frames over high-speed links.

Some conventional approaches rely on a tight coupling between the command field and the sequence number, which limits the TX to include either the TX sequence number or the RX sequence number in the header for acknowledgment or replay request in addition to presenting several other challenges. For example, these other challenges can include overcoming the dependency of conventional approaches, which may necessitate comprehensive redesigning of the system architecture. Some conventional approaches also are not scalable as more efficient and advanced replay mechanisms (e.g., selective replay with outstanding depth >1) cannot be developed since the RX quickly loses the ability to infer the correct TX sequence number after prior flit corruption. Additionally, the TX sequence number not being sent with a data flit of a datagram can cause performance issues, which can be challenging to debug.

As a result, some approaches have previously been proposed to attempt to overcome the dependency between the command field and the sequence number. However, these approaches prioritize one type of sequence number or the other and may result in unpredictable systematic performance issues in complex scenarios. One approach prioritizes sending TX sequence numbers. However, this would hinder the link partner’s transmit release buffer release and would increase the RX blackout time from the postponed replay request. Another approach prioritizes using RX sequence numbers. However, this approach may cause more potential ambiguity on the link.

In contrast, by sending the full TX sequence number in the data flit, the various embodiments described herein can provide replay support that can reduce the design complexity of a system’s architecture. The embodiments described herein can also demonstrate improved system performance by eliminating ambiguity arising from missed TX sequence numbers. The RX may receive the TX sequence number in the header of each data flit received from the link partner, without dependency on the validity of previous flits. The replay support provided by the embodiments described herein may also allow for implementation of more sophisticated and efficient replay mechanisms like being capable of selectively replaying multiple discontinuously corrupted data flits instead of blindly replaying all data flits in the TX buffer. The embodiments described herein can therefore provide replay support functionality that can improve link performance and reliability, improve effective bandwidth, and reduce overall latency in communications. Moreover, some of the improvements described herein may address the demand for higher link speeds and the challenges from longer loop latencies for certain applications.

According to some embodiments, the TX can send data flits including a partial TX sequence number in the header to the RX side of the link partner. Sending data flits including the partial TX flit sequence number in the header can, in some embodiments, increase the tolerance of ambiguity on the RX side of the link.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

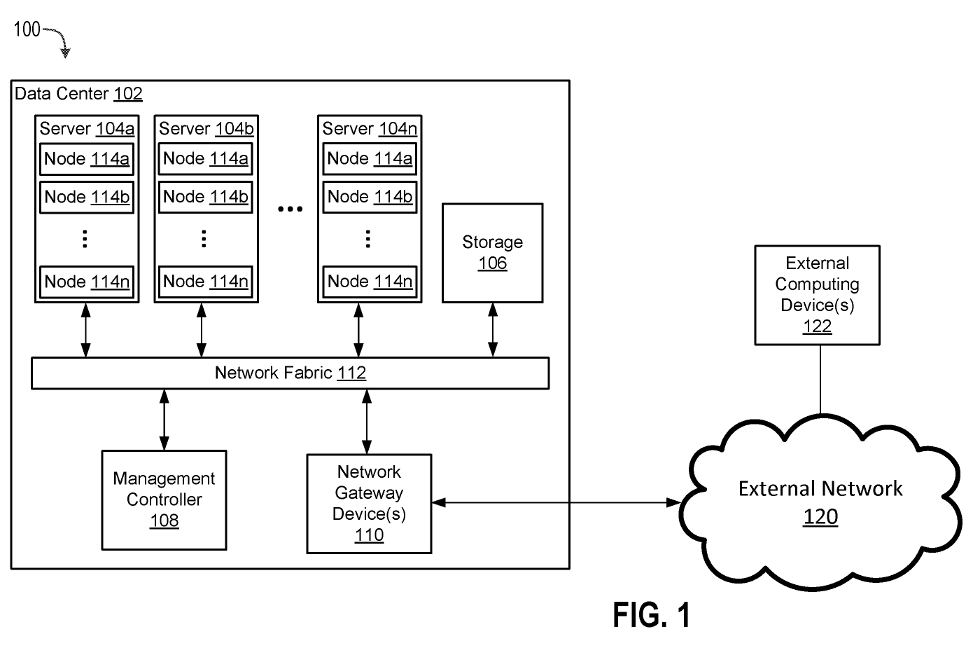

FIG. 1 illustrates a block diagram of an exemplary system 100, according to some embodiments. The system 100 may be configured to implement the techniques described herein, although other systems are possible. It should be appreciated that FIG. 1 is intended neither to be a depiction of necessary components for a data center or components thereof to operate in accordance with the principles described herein, nor a comprehensive depiction. System 100 can include additional components, omit one or more of the described components, multiple instances of a component even if only one instance is shown in FIG. 1, and/or can be organized in other suitable manners.

Referring to FIG. 1, system 100 may include a data center 102. The data center 102 may be communicatively connected to an external network 120. The data center 102 may receive processing requests from external computing device(s) 122 via the external network 120. The data center 102, or one or more components thereof, may be utilized to perform a plurality of processing tasks using at least some portion of the processing resources of data center 102. For example, data center 102 may utilize one or more processing resources of data center 102 to fulfill a processing request from external computing device 122 received via external network 120.

Data center 102 may in some embodiments include multiple servers 104, each of which may be communicatively connected to a network fabric 112. Data center 102 may also in some embodiments include one or more other components including, for example and without limitation, storage device 106, management controller 108, and network gateway device(s) 110, each of which may be communicatively coupled with one or more other components of the data center 102 over the network fabric 112.

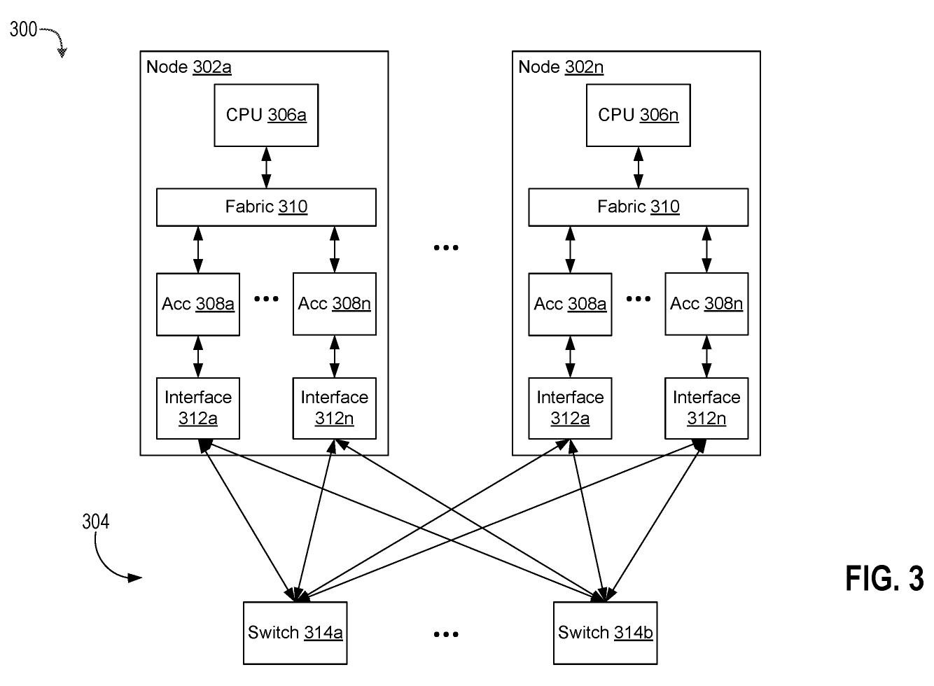

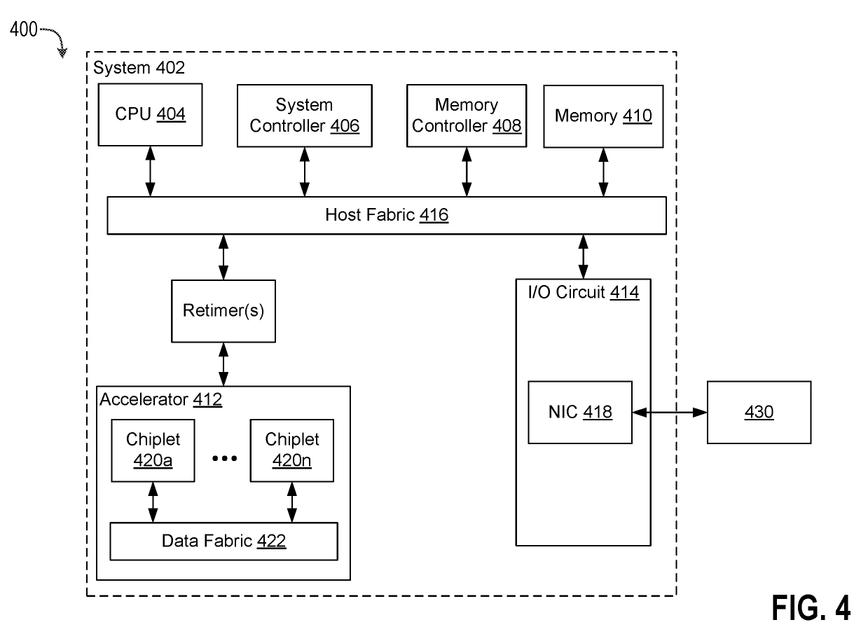

The multiple servers 104 (shown as servers 104a, 104b, through 104n) each may include multiple nodes 114 (shown as nodes 114a, 114b, through 114n). Each node 114 may include one or more functional units or components having a suitable architecture for performing the high performance computing or machine learning operations, as will be further described herein with regards to FIGS. 3 and 4. For example, each node 114 may include an integrated circuit including one or more processors (e.g., CPU cores), memory controllers, GPUs, I/O interfaces, accelerators (e.g., AI engines), among other functional units, arranged on a system-on-chip (SoC), and which may be communicatively coupled together over an interconnect fabric as a network-on-chip (NoC).

While the embodiment depicted in FIG. 1 illustrates servers 104 that include the nodes 114, each node 114 may include processing and storage resources and may be directly connected to network fabric 112 in other embodiments, such that there may not be any element considered to be a server 104 or such that each node 114 may be considered a separate server 104.

The storage device 106 may include a variety of different types of computer-readable media for storing data, programs, instructions, etc. for use by the plurality of processing nodes 114 of the plurality of servers 104. For example, storage device 106 can include any combination of random access memory (RAM), read only memory (ROM); electronically erasable programmable read only memory (EEPROM), flash memory, or other memory technologies; CD-ROM, digital versatile disks (DVD), or other optical or holographic media; magnetic cassettes, magnetic tape, magnetic disk storage, or other magnetic storage devices that can be used to encode information and can be accessed by the plurality of processing nodes 114. The storage device 106 can include computer-storage media in the form of volatile and/or nonvolatile memory. The storage device 106 may be removable, non-removable, or any combination thereof. For example, storage device 106 can include hardware devices such as hard drives, solid-state memory, optical-disc drives, and the like. The data center 102 may, in some embodiments, include multiple storage devices such as storage device 106, even though only one is depicted in the illustrated embodiment.

The management controller 108 may be connected to one or more other components of 102// including the servers 104, storage device 106, network gateway device(s) 110, among other components of data center 102 not described herein. The management controller 108 may include any combination of hardware, software, and firmware to assist in orchestration of each server 104 and the corresponding nodes 114 in performing the processing tasks, which may include controlling storage, communications, timing, frequency, etc. within the data center 102 and/or between components of the servers 104 and other systems (e.g., external client devices).

The network gateway device(s) 110 may communicatively connect data center 102, or one or more portions thereof, to one or more other components such as external computing devices 122 via the external network 120. Accordingly, data center 102 can receive requests, and data associated therewith, from the external computing devices 122 via the network gateway devices 110 and can transmit data from data center 102 to the external computing devices 122 via the network gateway devices 110 responsive to the requests from the external computing devices 122 over the external network 120. For example, management controller 108 may receive processing requests from the network gateway devices 110 and the management controller 108 may orchestrate fulfillment of the request using one or more of the plurality of processing nodes 114 of the plurality of servers 104 in accordance with the user request, the network gateway devices 110 having received the processing requests from the external computing devices 122 over external network 120.

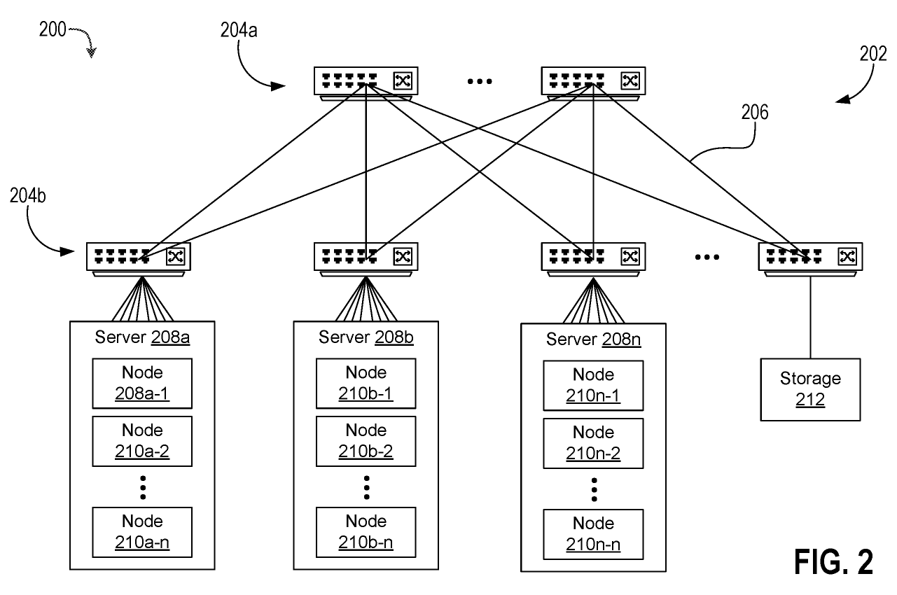

FIG. 2 illustrates a diagram of an exemplary system 200, according to some embodiments. The system 200 may be configured to implement some techniques described herein, although other systems are possible. System 200 may be implemented with any combination of components and/or subsystems of system 100.

It should be appreciated that FIG. 2 is intended neither to be a depiction of necessary components for a data center or components thereof to operate in accordance with the principles described herein, nor a comprehensive depiction. The system 200 can include additional components, omit one or more of the described components, multiple instances of a component even if only one instance is shown in FIG. 2), and/or can be organized in other suitable manners.

In some examples, system 200 may include a network fabric 202 coupled to one or more components including a plurality of servers 208 (shown as servers 208a, 208b, through 208n). The one or more other components may include any of the components or sub-systems of system 100. Each of the plurality of servers 208 may include a plurality of nodes 210 for fulfilling processing tasks received from, for example, management controller 108 of FIG. 1. For example, referring to FIG. 2, server 208a may include nodes 210a-1, node 210a-2, through node 210a-n. For example, the one or more other components of system 200 may include storage 212, which may be connected to network fabric 202 to enable the plurality of servers 208 and the plurality of processing nodes 210 of each of the plurality of servers 208 to store and retrieve data from storage 212.

The network fabric 202 may include a plurality of switches 204 interconnected together via one or more interconnect links 206 such that each switch 204 of the plurality of switches 204 may be connected to one or more other components of system 200. In some examples, the plurality of switches 204 of network fabric 202 may include spine switches 204a and leaf switches 204b. The spine switches 204a may be used to interconnect one or more leaf switches 204b. The leaf switches 204b may interconnect one or more servers to the spine switches 204a. The leaf switches 204b may serve as an access switch that aggregates data traffic from servers and forwards the data to the spine switches 204a for transmission to its intended destination. The leaf switches 204b may be referred to as top-of-rack switches, and which may be used to connect to the plurality of processing nodes 210 of a given server 208 to enable data transmission and resource sharing between the plurality of processing nodes 210 of the given server 208 and/or data transmission and resource sharing between nodes 210 of respective servers of the plurality of servers 208.

The interconnect links 206 be used for serialized data transmission between at least two components of system 200 over one or more lanes at a defined serial rate. In some examples, one or more of the interconnect links 206 may be defined in accordance with 200 Gigabit communication standard. In some embodiments the one or more of the interconnect links 206 may be defined for 1, 2, or 4 serial lanes capable of running at a serial rate of 212.5 Gbps. For example, the interconnect links 206 may be designed in accordance with 200GBASE-KR1/CR1, 400GBASE-KR2/CR2, and/or 800GBASE-KR4/CR4 standards. In some examples, one or more of the interconnect links 206 may be defined in accordance with 100 Gigabit communication standard. In some embodiments the one or more of the interconnect links 206 may be defined for 1, 2, or 4 serial lanes capable of running at a serial rate of 212.5 Gbps. For example, the interconnect links 206 may be designed in accordance with 100GBASE-KR1/CR1, 200GBASE-KR2/CR2, 400GBASE-KR4/CR4 standards.

FIG. 3 illustrates a block diagram of an exemplary system 300, according to some embodiments. The system 300 may be configured to implement some techniques described herein, although other systems are possible. System 300 may be implemented with any combination of components and/or subsystems of system 100 and system 200.

System 300 may include one or more processing nodes 302 (shown as processing node 302a through processing node 302n) each coupled to an interconnect fabric 304. Interconnect fabric 304 may also be referred to herein as a network fabric. Each processing node 302 may be coupled to one or more other components of system 300 over the interconnect fabric 304. In some examples, each processing node 302 may be connected to one or more other processing nodes 302 over interconnect fabric 304 for data transmission and resource sharing purposes. In

some examples, a server such as server 208 of FIG. 2 may include the one or more computer systems 402 as processing nodes. In some examples, each processing nodes 302 may be selectively utilized to perform a processing or rendering operation either discretely or in parallel with one or more other processing nodes 302 in accordance with some orchestration scheme as determined by, for example, management controller 108 of FIG. 1.

In some examples, each processing node 302 may include a central processing unit (CPU) 306 (shown as CPUs 306a through 306n), a plurality of accelerators 308 (shown as accelerators 308a through 308n), and one or more interfaces 312 (shown as interfaces 312a through 312n), some or all of which may be communicatively connected through data fabric 310 (or other connection circuitry). In some examples, the CPU 306, plurality of accelerators 308, and data fabric 310 may be coupled to (e.g., mounted on) a printed circuit board (e.g., motherboard).

The CPU 306 may be configured to process data and execute instructions of an operating system and/or instructions (e.g., program code) of one or more applications. In some examples, the functionality of the program code may be implemented by one or more of the CPU 306, one or more processor chiplets of a CPU 306, and/or one or more cores of a processor chiplet of a CPU 306. The data and instructions can be stored on a memory (not shown) coupled to CPU 306. The data and instructions can comprise computer-executable instructions implementing any suitable functionality.

In some examples, as part of executing a given software application, the CPU 306 launches rendering tasks to be performed on the plurality of accelerators 308. It should be appreciated that although FIG. 3 shows plurality of accelerators 308, the processing node 302 may include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc.), or a combination thereof, that can perform the rendering tasks or other processing operations described herein.

In some examples, a host fabric 310 connects CPU 306 and plurality of accelerators 308, and other components within the processing node 302. The host fabric 310 may include any type of communication fabric, bus, and/or other control and interface logic for facilitating the communication of data between various components of the processing node 302. For example,

the host fabric 310 may include data paths, switches, routers, and other logic used to communicate data among the various components. In some embodiments, the host fabric 310 may be bus-based, including shared bus configurations, crossbar configurations, and hierarchical buses with bridges. host fabric 310 may also be packet-based, and can be hierarchical with bridges, crossbar, point-to-point, or other interconnects.

In some examples, each processing node 302 may further include one or more interface devices 312. The one or more interface devices 312 may be used to communicatively connect the accelerators 308 of a processing node 302 to one or more other accelerators 308 of another processing node 302 for data transmission and resource sharing purposes over interconnect fabric 304. For example, one or more accelerators 308 of processing node 302a may be connected to the one or more accelerators 308 of processing node 302n over the interconnect fabric 304 for data transmission and resource sharing. For example, the one or more interface devices 312 may be network interface cards (“NICs”) for connecting the plurality of accelerators 308 of processing node 302 to the interconnect fabric 304 and one or more other components of the system 300. In some examples, interconnect fabric 304 may include a plurality of switches including at least switch 314a and 314b, and one or more of the plurality of accelerators 308 of processing node 302a may be communicable connection to one or more of the plurality of accelerators 308 of processing node 302n through at least one of switch 314a and switch 314b of interconnect fabric 304. In some embodiments, the interconnect fabric 304 may include a plurality of switches including switch 314a and switch 314b, among other switches, nodes, routers, and the like, for data transmission between the nodes 302.

It should be appreciated that system 300 of FIG. 3 may further include one or more interface devices (e.g., NICs), and each CPU 306 may be connected to a respective interface device to enable front-end communication between the processing node 302 and one or more other components of system 300 over the interconnect fabric 304. For example, management controller 108 may send processing instructions to CPU 306 through the respective interface device.

It should be appreciated that FIG. 3 is intended neither to be a depiction of necessary components for a processing node or components thereof to operate in accordance with the principles described herein, nor a comprehensive depiction. The system 300 can include additional components, omit one or more of the described components, multiple instances of a component even if only one instance is shown in FIG. 3, and/or can be organized in other suitable manners.

FIG. 4 is a block diagram of an exemplary system 400 configured to implement the techniques described herein, according to some embodiments. The system 400 may be configured to implement the techniques described herein, although others are possible. System 400 may be implemented with any combination of components and/or subsystems of system 100, system 200, and system 300.

System 400 may include a computer system 402. Computer system 402 may be or otherwise be included within, for example, a desktop computer, a video game console, a server, a wireless access point or other networking element, a mobile computing device (e.g., laptop computers, tablets, smartphones, smartwatches, implantable health monitoring devices, wearable computers, personal digital assistants, etc.), or any other suitable computing system. It should be appreciated that FIG. 4 is intended neither to be a depiction of necessary components for a computer system or device to operate in accordance with the principles described herein, nor a comprehensive depiction. The computer system 400 can include additional components, omit one or more of the described components, multiple instances of a component even if only one instance is shown in FIG. 4, and/or can be organized in other suitable manners.

In some examples, the computer system 402 may be a processing node, which may include a central processing unit (CPU) 404, a system controller 406, a memory controller 408, a memory 410, an accelerator 412, and an I/O circuit 414, which may each be communicatively attached through host fabric 416 (or other connection circuitry). In some examples, the CPU 404, system controller 406, accelerator 412, memory 410, and host fabric 416 are coupled to (e.g., mounted on) a printed circuit board (e.g., motherboard).

The CPU 404 can include any combination of processing units, for example, one or more processor chiplets, each including one or more cores. In some examples, the processor chiplets (or other processing units) can communicate with each other via interconnects routed through or on a package substrate. The CPU 404 is configured to process data and execute instructions of an operating system and/or instructions (e.g., program code) of one or more applications. In some examples, the functionality of the program code may be implemented by one or more of the CPU 404, one or more processor chiplets of a CPU 404, one or more cores of a processor chiplet, and/or the accelerator 412. The data and instructions can be stored on memory 410. The data and instructions stored on any of the computer-readable storage media (e.g., memory 410, registers, internal or external of the CPU 404, caches of the accelerator 412, etc.) can comprise computer-executable instructions implementing any suitable functionality.

The memory 410 can include a variety of computer-readable media for storing data, programs, instructions, etc. for use by the computer system 402. For example, memory 410 can include any combination of random access memory (RAM), read only memory (ROM); electronically erasable programmable read only memory (EEPROM); flash memory or other memory technologies; CD-ROM, digital versatile disks (DVD) or other optical or holographic media; magnetic cassettes, magnetic tape, magnetic disk storage or other magnetic storage devices that can be used to encode information and can be accessed by the CPU 404 and/or the accelerator 412. The memory 410 can include computer-storage media in the form of volatile and/or nonvolatile memory. The memory 410 may be removable, non-removable, or any combination thereof. For example, memory 410 can include hardware devices such as hard drives, solid-state memory, optical-disc drives, and the like.

In some examples, as part of executing a given software application, the CPU 404 launches rendering tasks to be performed on the accelerator 412. The accelerator 412 can include a graphics processing unit (GPU), accelerated processing unit (APU), vision processing unit (VPU), tensor processing unit (TPU), physics processing unit (PPU), digital signal processing (DSP) circuit, field programmable gate array (FPGA), application-specific integrated circuit (ASIC), etc.), or a combination thereof.

In some examples, a host fabric 416 connects CPU 404, memory 410 (directly of via one or more memory controllers 408), accelerator 412, I/O circuitry 414, and other components within the system 402. The host fabric 416, can include any type of communication fabric, bus, and/or other control and interface logic for facilitating the communication of data between various components of the computer system 402. For example, the host fabric 416 can include data paths, switches, routers, and other logic used to communicate data among the various components. In some embodiments, the host fabric 416 can be bus-based, including shared bus configurations, crossbar configurations, and hierarchical buses with bridges. Host fabric 416 can also be packet-based, and can be hierarchical with bridges, crossbar, point-to-point, or other interconnects. The host fabric 416 is configured to route memory access requests and memory responses between any memory accessing components and/or the one or more memory controllers 408. The host fabric 416 can also include a system memory map (e.g., defined by BIOS) for determining destinations of memory accesses based on the system configuration.

In some examples, the computer system 402 includes a system controller 406, which may include one or more circuits. Each of the CPU 404, the memory 410 (directly of via one or more memory controllers 408), the accelerator 412, host fabric 416, and the I/O circuitry 414 can be bidirectionally connected to a system controller 406 (or power management controller), which forms a control fabric and is configured to provide memory access requests to host fabric 416. The system controller 406 can include a combination of hardware, software and firmware to assist in controlling storage, communications, timing, frequency, etc. within the computer system 402 and/or between parts of the computer system 402 and other systems (e.g., client devices).

For example, the system controller 406 manages power-up sequencing of the various processors and includes one or more clock sources (e.g., a phase locked loop (PLL)), to provide clock signals for each of the components of the computer system 402. The system controller 406 also manages power for the various processors and other functional blocks, and may receive measured power consumption values from CPU 404 and accelerator 412 to determine appropriate power states. The computer system 402 also implements various system monitoring and power saving functions, for example, thermal monitoring. The computer system 402 can assist in tracking mitigating action based on such monitoring. For example, if the computer system 402 becomes hot, then system controller 406 can reduce the frequency and voltage of CPU 404 and/or accelerator 412 or shut down the computer system 402 entirely. In some examples, the system controller 406 can control and/or trigger proactive and/or reactive mitigation actions to be taken based on monitored criteria. For example, the system controller 406 initiate proactive dynamic workload control and/or reactive “big hammer” actions such as drastic clock frequency reduction.

The one or more memory controllers 408 are configured to control the flow of data to and from the memory 410. For example, the memory controller 408 can handle the reading and writing of data to and from the memory 410, schedule access to the memory 410 to optimize bandwidth and latency, detect and correct errors in data stored in memory, translate logical addresses into physical addresses, adjust the use of available memory bandwidth to maximize performance, among other tasks.

In some examples, the I/O circuitry 414 may be configured to physically connect and communicatively with one or more other components. In some examples, the I/O circuitry 414 may include a network interface card (NIC) 418 to connect the computer system 402 to an interconnect fabric 430 of a network system such as, for example and without limitation, system 100 of FIG. 1. In some examples, the NIC 418 may be a standalone card separate from the I/O circuitry 414.

In some examples, the I/O circuitry 414 may be configured to physically connect to peripheral devices and control the flow of data to and from the memory 410 and/or storage. Some non-limiting examples of an input device can include a mouse, keyboard, scanner, video game controller, microphone, webcam, etc. Some non-limiting examples of an output device can include a display, printer, speakers, headphones, earbuds, etc. The I/O circuitry 414 can include any suitable type of peripheral connector(s), including, without limitation, universal serial bus (e.g., USB-A, USB-B, USB-C, USB-3.0, etc.), Ethernet, DisplayPort, high-definition multimedia interface (HDMI), peripheral component interconnect (PCI), peripheral component interconnect eXtended (PCI-X), peripheral component interconnect express (PCIe), accelerated graphics port (AGP), etc. In some examples, portions of the I/O circuitry 414 can be integrated into a motherboard and/or motherboard chipset (e.g., I/O circuitry 414) of the computer system b.

As described above, computer system 402 may have one or more components and peripherals, including input and output devices. These devices may be used, among other things, to present a user interface. Examples of output devices that can be used to provide a user interface include display screens for visual presentation.

In some examples, the accelerator 412 may include any combination of processing units, for example, one or more processor chiplets, each including one or more cores. In some examples, the processor chiplets (or other processing units) can communicate with each other via a data fabric 422 comprising interconnects internally routed between each of the chiplets 420a through 420n of accelerator 412. Each chiplet 420 may in some examples be packaged from one or more dies, and the header modification techniques described herein may be implemented to enable data transmission between the chiplets 420. The interconnects may in some embodiments be routed through or on a package substrate to connect the chiplets 420a through 420n. The accelerator 412 may be configured to process data and execute instructions of CPU 404 and/or instructions (e.g., program code) of one or more applications. In some examples, the functionality of the program code may be implemented by one or more of the accelerators 412, one or more processor chiplets of accelerator 412, one or more cores of a processor chiplet, and/or the CPU 404. The data and instructions may be stored on memory 410 and/or memory (not shown). The data and instructions stored on any of the computer-readable storage media (e.g., memory 410, registers, internal or external of the CPU 404, caches of the processing unit 420, etc.) can comprise computer-executable instructions implementing any suitable functionality.

The flit header modification techniques described herein may be implemented in one or more systems, or one or more portions thereof, such as in system 400 or some other system such as, for example, system 100 of FIG. 1, system 200 of FIG. 2, and system 300 of FIG. 3, among other systems. In some examples, system 402 may include a computer architecture including any suitable combination of hardware, software, or firmware to implement the encoding of the TX and RX sequence numbers into flit headers in accordance with the techniques described herein to indicate the sequence number of a transmitted flit and the sequence number of a previously received flit for acknowledgement or replay request. In some embodiments, the flit header modification techniques may include encoding the TX sequence number with the RX sequence number into the header when sending acknowledge (ACK) or replay request (NAK) flits. Including the TX sequence number with the RX sequence number into the header of data flits for communication between link partners reduces communication bandwidth, thereby enabling faster communication between link partners. The flit header modification techniques also reduces the complexity that can be associated with solving conflicts between sending TX or RX numbers, improves scalability of systems by enabling more efficient and advanced replay mechanisms since the RX can identify the correct TX sequence number after prior flit corruption, improves ambiguity that can arise from the TX sequence number not being sent, reduces challenges associated with debug operations, and can improve the system performance issues commonly associated with complex scenarios. Sending the TX sequence number and the RX sequence number in flit headers improves upon challenges stemming from prioritizing sending TX sequence numbers including improving the link partner’s transmit buffer release and increasing the RX blackout time from the postponed replay request. Additionally, sending the TX sequence number and the RX sequence number in flit headers improves upon challenges stemming from prioritizing sending RX sequence numbers in flit headers including the increased likelihood of potential ambiguity on the link from inferring TX sequence numbers.

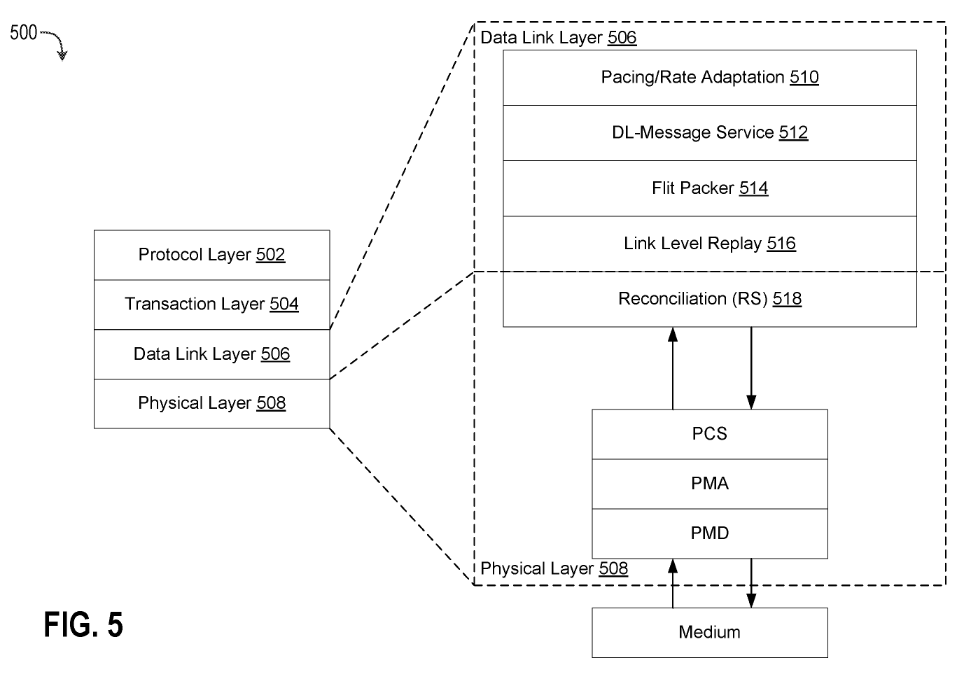

FIG. 5 illustrates an example diagram of a portion of an exemplary communication system 500 for implementing the TX and RX flit sequence numbers into the flit header of flits, according to some embodiments. Communication system 500 may be configured to implement the techniques described herein, although others are possible. Communication system 500 may be implemented with any combination of components and/or subsystems of system 100, system 200, system 300, and system 400.

Communication system 500 described herein may be designed to facilitate implementing the TX and RX flit sequence numbers into the flit header of replayable flits for transmission through a data link layer and for a physical transmission over a medium such as, for example, interconnect link 430 of FIG. 4. Communication system 500 may be structured in accordance with a protocol, which may in some embodiments include one or more layers, and each layer may include one or more sub-layers, thereby ensuring robust and efficient data exchange between link partners.

In some examples, system architecture of communication system 500 may include a protocol layer (PL) 502, a transaction layer (TL) 504, a data link layer (DL) 506, and a physical layer (PHY) 508. Each of these layers may be responsible for specific functions that collectively enable seamless communication between link partners. The communication system 500 may carry messages between a sender and receiver in accordance with the layers of communication system 500. In addition, the communication system 500 may be a symmetrical protocol with the same set of messages and channels supported in both transmit and receive paths. During communication, these messages may traverse through multiple functional layers of the communication system 500 in the journey between sender and receiver (e.g., originator and transmitter).

The PL 502 may define a logical signaling interface and a protocol by which devices can exchange data and control information through a set of Request and Response messages. The PL 502 of communication system 500 may define the protocol and may expect implementations that follow this protocol will be compatible with the interconnect fabric such as, for example, network fabric 112. The communication system 500 may include built-in flexibility to allow vendors to create custom protocol messages for communication between processing units without any modification to the interconnect switches.

The TL 504 may be coupled to two PL interfaces (not shown), one interface may be communicatively coupled to an originator device via PL 502 and the other interface may be communicatively coupled to a completer device via PL 502 (not shown). The TL 504 may drive a 54-byte outbound TX flit to the DL 506 and may receive from the DL 506 a 54-byte inbound RX flit. The channels driven into the TL 504 from both interfaces may be packaged into 54-byte outbound TX flits, which may be transmitted to the DL 506. Similarly, the RX 54-byte TL flit from the DL 506 may be unpacked into request, read response/data, orig data, and write response channels for the two interfaces coupled to the TL 504, which may be transmitted to one of the originator or completer devices.

The DL 506 may receive 54B flits from the TL 504 and may package these flits into 540B flits in the transmit direction and may send them to the PHY 508. Similarly, in the receive direction the DL 506 may receive 540B flits from the PHY 508 and unpacks then into 54B flits and then sends them to the TL 504. The DL 506 may provide a control message service used for coordinating changes to the link, i.e., online/offline, and other features.

In some examples, the DL 506 may provide a mechanism for adding the TX and RX flit sequence numbers into the flit header of replayable flits to be passed across the interconnect link between link partners such as, for example, originator and completer device. Referring to FIG. 5, the DL 506 may include a pacing/rate adaptation sublayer 510, DL-message service sublayer 512, flit packer sublayer 514, link level replay sublayer 516, and reconciliation sublayer 518. In some examples, the TX and RX flit sequence numbers into the flit header of replayable flits may be implemented at the link level replay sublayer 516, which may be used to revise the flit header of a DL flit to send the TX sequence number when sending the Acknowledge (ACK) or Replay Request (NAK) flits, as will be further described herein.

The PHY 508 may support one or more rates of serial communication over an interconnet link between two link partners. In some examples, the PHY 508 may support 200G serial transmission including, for example and without limitation, 200GBASE-KR1/CR1, 400GBASE-KR2/CR2, and 800GBASEKR4/ CR4. In some examples, the PHY 508 may also support 100G serial transmission including, for example and without limitation, 100 GBASE-KR1/CR1, 200 GBASE-KR2/CR2, 400 GBASE-KR4/CR4. To reduce latency at the 200G serial rates, 1-way and 2- way code word interleave modes may be supported, in addition to the standard 4-way interleave. To improve latency each DL Flit may be packed uniquely into a single 580-Byte code word. The additional 40-bytes may be for FEC overhead and 256B/257B line coding.

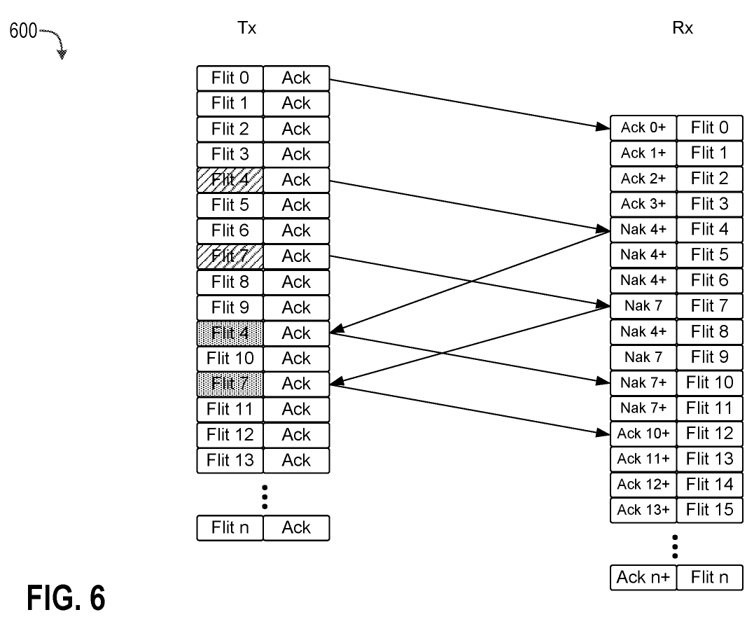

FIG. 6 illustrates an exemplary data transmission 600 of flits between a transmitter and receiver of link partners, according to some embodiments. The data transmission 600 may be implemented in accordance with the techniques described herein, although others are possible. Data transmission 600 may be implemented with any combination of components and/or subsystems of system 100, system 200, system 300, system 400, and communication system 500.

In some examples, responsive to the Acknowledge (ACK) or Replay Request (NAK) flits from RX, the TX may also send the TX sequence number along with the RX sequence number in the DL flit sent to the RX. For example, referring to FIG. 6, the TX may send the TX sequence number along with the RX sequence number in the second flit 4 responsive to the NAK flit for flit 4 from the RX. Without the TX sending the TX sequence number along with the RX sequence number responsive to ACK and NAK flits, the flits from the TX may become unrecognizable on the RX side after flit 4 and flit 7 are corrupted. However, the flit header carrying the TX sequence number despite it using the ACK command enables all subsequent flits from the TX to be correctly received, recognized, and accepted regardless of how many flits may be corrupted before them. In this regard, the techniques described herein may reduce latency because the corrupted bits may be the only flits that may be replayed by the TX due to corruption instead of all the subsequent flits.

In the embodiments that send the full TX flit sequence number and the RX flit sequence number in each flit, complexity of design to solve for confliction between sending RX or TX sequence numbers may be reduced along with reducing unpredictable performance issues in complex scenarios, and ambiguity from not sending the TX flit sequence number with the RX flit sequence number may be reduced or eliminated. The RX may thereby determine the TX sequence number of the received flit without dependency on the validity of previous flits. This also enables more sophisticated and efficient replay mechanisms by selectively replaying multiple discontinuously corrupted flits instead of blindly replaying all flits in the TX buffer, thereby improving link performance, effective bandwidth, and reducing overall latency. These techniques may be applied to processing and rendering applications to address the challenges from high-speed communications and longer loop latencies.

In some examples, the TX may send the TX sequence number in full or partially (“N” bit LSBs). When configured to send the full form of the TX sequence number in headers of flits, link partners may be configured such that the TX sequence number inference functionality may be removed from the RX, and the TX/RX sequence number arbitration functionality may be removed from the TX. When configured to send only “N” bit LSBs of the TX sequence number, ambiguity handling logic may be added on the RX side of the link partner for increased tolerance of ambiguity on the TX side of the link partners to the partial TX sequence number. The link partners of systems may be designed using any suitable combination of hardware, software, or firmware to include or remove the functionalities described herein, thereby improving the respective link partners and overcoming some of the challenges associated with the dependency from the tight coupling between the command field and the sequence number field of some conventional link partners that communicate using flits. In some examples, the RX may include circuitry designed without the TX sequence number inference functionality. In some examples, the TX may include circuitry designed without the TX/RX sequence number arbitration functionality. In some other examples, the RX may include a circuit including ambiguity handling logic for increased tolerance of ambiguity from partial TX sequence numbers.

In some examples, the ambiguity handling logic may include a low mask value, a high mask value, a fSeqLo value, a fSeqHi value, and a fSeq Hi_inc value. The Low mask value may be: LOW_MASK = ((0x1<<N)-1); the high mask value may be: HIGH_MASK = ((0x1<<width of TX sequence number) – 1) ^ LOW_MASK; the fSeqLo value may be: fSeqLo = current_rx_fSeq & LOW_MASK; the fSeqHi value may be: fSeqHi = current_rx_fSeq & HIGH_MASK; and the fSeqHi_inc value may be fSeqHi_inc = fSeqHi_inc + (0x1<<N). In addition, the ambiguity handling logic may include if (fSeqLo <= TXSeq_received), fSeq_resolved = fSeqHi | fSeqLo; else fSeq_resolved = fSeqHi_Inc | fSeqLo.

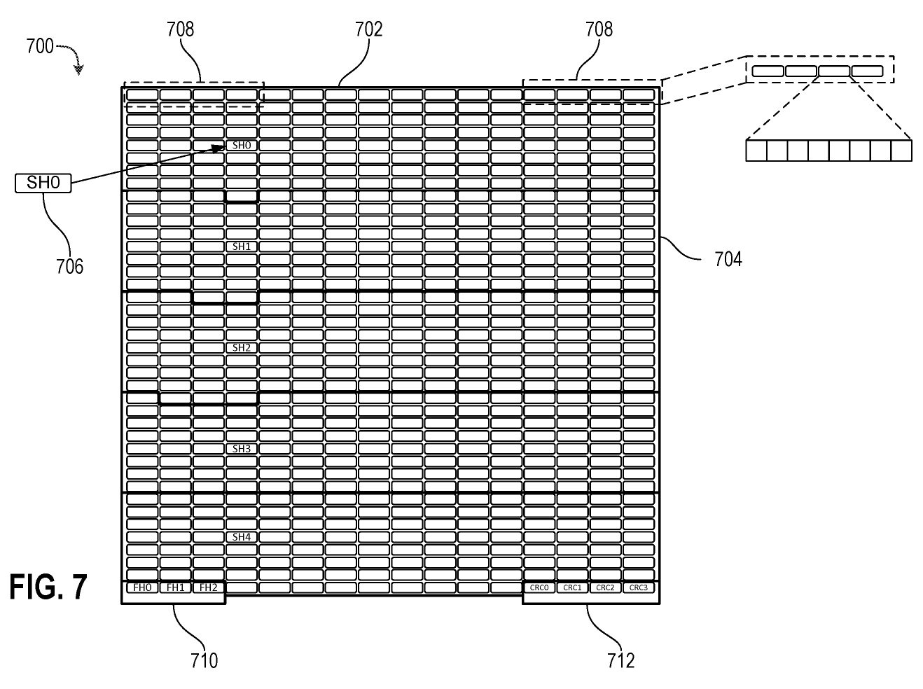

FIG. 7 illustrates an exemplary datagram 700 for carrying the TX and RX sequence numbers in data flits, according to some embodiments. The datagram 700 may be implemented in accordance with the techniques described herein, although others are possible. Datagram 700 may be implemented with any combination of components and/or subsystems of system 100, system 200, system 300, system 400, communication system 500. Datagram 700 may be utilized in data transmission 600 between link partners.

The datagram 700 may be a DL flit 702. The DL flit 702 may include n number of data segments 704. Each data segment 704 of the n number of data segments 704 may include a segment header 706 (shown as SH0, SH1, SH2, SH3, and SH4) and m number of sectors 708, with each sector 708 having a predefined number of bytes. For example, each segment 704 may include 128-bytes (e.g., 1,024-bits), each sector 708 may include 4-bytes (e.g., 32-bits), and each segment header 706 may include 1-byte (e.g., 8-bits). The each segment header 706 may describe the data that starts or is packed in the data segment 704. The m number of sectors 708 may be for packing a data payload.

Up to two TL flits may be packed into each segment 704. In some embodiments, each segment 704 may include a first portion for receiving up to a 64-byte TL flit and a second portion for receiving up to a 64-byte TL flit. The first portion and the second portion may, in some embodiments, each include m/2 sectors 708 of the respective segment 704. In some embodiments, some segments 704 may include alternative sectors, which may cause some of the TL flit sequence to carry over into a next segment 704 of the DL flit 702. The segment header 706 of each segment 704 may include data characterizing if there is data packed into the alternative sector, the first portion (e.g., first TL flit), the second portion (e.g., second TL flit), and the presence of messages in the respective portions.

The DL flit 702 may also include a flit header 710 and a CRC 712 that may be appended to the DL flit 702 such that one or more of the data segments 704 may include less than m number of sectors 708 for packing the data payload. The flit header 710 may indicate the type of data and sequence number to aid in link level replay, and other information. The CRC 712 may be a calculated value characterizing the contents of the DL flit 702. In some examples, the flit header 710 may include the TX and RX sequence numbers when the TX sends the ACK flit and the NAK flits.

Flit header 710 may indicate whether a given DL flit 702 is a payload flit (e.g., explicit sequence number flit) or an ACK or NAK flit (e.g., command flit). Some DL flits 702 may be payload flits transmitted between link partners, which may include a TX sequence number in flit header 710. In some embodiments, DL flits 702 that are payload flits may not include the RX sequence number. In some examples, the TX sequence number may be a 9-bit sequence number in flit header 710 of DL flits 702 that are payload flits. Some DL flits 702 may be ACK or NAK flits transmitted between link partners, which may include a RX sequence number and a TX sequence number. In some embodiments, DL flits 702 that are ACK or NAK flits transmitted between link partners may include a RX sequence number and a partial TX sequence number in flit header 710. When flit header 710 includes the partial TX sequence number, the full TX sequence number may, in some embodiments, be inferred by the RX based on previously received full TX sequence number, and subsequent TX sequence number, which may be a partial TX sequence number. In some examples, the RX sequence number in flit header 710 of flit 702 may be 9-bit sequence number and the TX sequence number of flit header 710 of flit 702 may be a 3-bit sequence number. The RX may, in some embodiments, perform checks to ensure that the full TX sequence number can be calculated based on the partial TX sequence number. If the full TX sequence number cannot be unambiguously determined by the RX or a circuit of the RX, the RX may trigger a replay request. The TX may, in some embodiments, schedules payload flits for transmission to the RX at a defined period. In some embodiments, the defined period may be after a certain number of payload flits to aid the RX in calculating the full TX sequence number from the partial TX sequence number received from the TX, thereby reducing ambiguity in the inferring of the full TX sequence number. Even though some of the embodiments described herein may describe the TX as packaging the flit including a flit header including the TX sequence number and the RX sequence number, it should be appreciated that the TX or the RX may transmit data packets including the TX sequence number and the RX sequence number in the respective header of the data packets to the other of the TX and the RX.

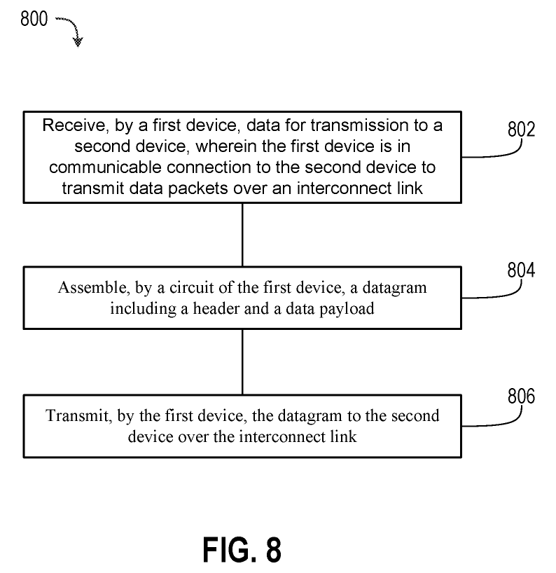

FIG. 8 is a flow diagram of a method 800 for data transmission of datagrams between link partners over an interconnect link, according to some embodiments. Method 800 may be implemented in accordance with the techniques described herein, although others are possible. Method 800 may be implemented with any combination of components and/or subsystems of system 100, system 200, system 300, system 400, and communication system 500, among other systems. Method 800 may be utilized in data transmission 600 of datagram 700 between link partners.

At 802, the method 800 may include receiving, by a first device, data for transmission to a second device. In some embodiments, the first device is in communicable connection to the second device to transmit data packets over an interconnect link.

At 804, the method 800 may include assembling, by a circuit of the first device, a datagram including a header and a data payload. In some embodiments, the datagram

At 806, the method 800 may include transmitting, by the first device, the datagram to the second device over the interconnect link. In some embodiments, responsive to a request from the second device, the circuit of the first device encodes a first sequence number and a second sequence number into the header of the data packet for transmission to the second device.

In some embodiments, the first sequence number is a transmitter sequence number characterizing a respective datagram being transmitted, and the second sequence number is a receiver sequence number characterizing a previously transmitted datagram. In some embodiments, the first sequence number is at least one of a partial sequence number or a full sequence number.

In some embodiments, the method 800 may further include inferring, by the second device responsive to the first sequence number being the partial sequence number in the header, the full sequence number based on a previously received full sequence number, and sending, by the second device responsive to failing to infer the full sequence number from the partial sequence number, a replay request datagram to the first device.

In some embodiments, the method 800 may further include sending, by the first device, a first datagram including the full sequence number in the header at a first clock cycle, sending, by the first device, a set of second datagrams including the partial sequence number in a respective header at a respective second clock cycles, and sending, by the first device, a third datagram including the full sequence number in the header at a third clock cycle. In some embodiments, the second device infers the full sequence number from the partial sequence number of a second datagram received during a second clock cycle based on the full sequence number of the first datagram. In some embodiments, the set of second datagrams are a defined number of datagrams.

In some embodiments, an apparatus includes a transmitter in communication with a receiver for data transmission over an interconnect link, each of the transmitter and the receiver including at least one circuit, the at least one circuit packages a header and a data payload into data packets for transmission to the other of the transmitter and the receiver. In some embodiments, responsive to a request from the transmitter or the receiver, the at least one circuit of the transmitter or the receiver encodes a first sequence number and a second sequence number into the header of the data packet for transmission to the other of the transmitter or the receiver.

In some embodiments, the data packet is a data flit.

In some embodiments, the first sequence number is a transmitter sequence number, and the second sequence number is a receiver sequence number.

In some embodiments, the first sequence number characterizes the data packet being transmitted.

In some embodiments, the first sequence number is at least one of a partial sequence number or a full sequence number, and the at least one circuit is configured to periodically send a data packet including the full sequence number in the header after a defined number of data packets including the partial sequence number in a respective header.

In some embodiments, the second sequence number characterizes a previously transmitted flit.

In some embodiments, a system includes a transmitter including a first circuit; and a receiver in communicable connection with the transmitter for transmission of data over an interconnect link, the receiver including a second circuit, each of the first circuit and the second circuit packages a header and a data payload into a data packet for transmission to the other of the transmitter and the receiver. In some embodiments, responsive to receiving a request from the transmitter or the receiver, a corresponding one of the first circuit or the second circuit is configured to encode a first sequence number and a second sequence number into the header of the data packet for transmission to the other of the transmitter and the receiver.

In some embodiments, the data packet is a data flit.

In some embodiments, the first sequence number is a transmitter sequence number, and the second sequence number is a receiver sequence number.

In some embodiments, the first sequence number characterizes the data packet being transmitted to the other of the transmitter and the receiver.

In some embodiments, the first sequence number is at least one of a partial sequence number or a full sequence number, and the corresponding one of the first circuit or the second circuit is configured to periodically send a data packet including the full sequence number in the header after sending a defined number of data packets including the partial sequence number in a respective header, to enable the other of the transmitter and the receiver to infer the full sequence number from the partial sequence number.

In some embodiments, the second sequence number characterizes a previously transmitted flit.

In some embodiments, the request is a replay request or an acknowledgement command.

In some embodiments, responsive to receiving the data packet from the transmitter or the receiver, the other of the transmitter and the receiver is configured to accept a previously received data packet stored at a buffer based on the first sequence number in the header of the received data packet.

In some embodiments, a method includes receiving, by a first device, data for transmission to a second device, wherein the first device is in communicable connection to the second device to transmit data packets over an interconnect link; assembling, by a circuit of the first device, a datagram including a header and a data payload; and transmitting, by the first device, the datagram to the second device over the interconnect link; wherein, responsive to a request from the second device, the circuit of the first device encodes a first sequence number and a second sequence number into the header of the datagram for transmission to the second device.

In some embodiments, the datagram is a data flit.

In some embodiments, the first sequence number is a transmitter sequence number characterizing a respective datagram being transmitted, and the second sequence number is a receiver sequence number characterizing a previously transmitted datagram.

In some embodiments, the first sequence number is at least one of a partial sequence number or a full sequence number.

In some embodiments, the method further includes inferring, by the second device responsive to the first sequence number being the partial sequence number in the header, the full sequence number based on a previously received full sequence number; and sending, by the second device responsive to failing to infer the full sequence number from the partial sequence number, a replay request datagram to the first device.

In some embodiments, the method further includes sending, by the first device, a first datagram including the full sequence number in the header at a first clock cycle; sending, by the first device, a set of second datagrams including the partial sequence number in a respective header at a respective second clock cycles; and sending, by the first device, a third datagram including the full sequence number in the header at a third clock cycle, the second device infers the full sequence number from the partial sequence number of a second datagram received during a second clock cycle based on the full sequence number of the first datagram, and the set of second datagrams are a defined number of datagrams.

Techniques operating according to the principles described herein can be implemented in any suitable manner. While the foregoing disclosure sets forth some examples using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered as non-limiting examples since many other architectures can be implemented to achieve the same functionality.

Included in the discussion above are flowcharts showing steps and acts in accordance with the present disclosure. The processing and decision blocks of the flowcharts above represent steps and acts that can be included in algorithms that carry out these processes. Algorithms derived from these processes (or steps thereof) can be implemented as software integrated with and directing the operation of one or more single- or multi-purpose processors (e.g., central processing units (CPUs), graphics processing units (GPUs), tensor processing units (TPUs), hardware accelerators, etc.), can be implemented as functionally-equivalent circuits such as a Digital Signal Processing (DSP) circuit, Field Programmable Gate Array (FPGA), or an Application-Specific Integrated Circuit (ASIC), or can be implemented in any other suitable manner. It should be appreciated that the flowchart(s) included herein do not depict the syntax or operation of any particular circuit or of any particular programming language or type of programming language. Rather, the flowchart(s) illustrate the functional information one of ordinary skill in the art can use to fabricate circuits or to implement computer software algorithms to perform the processing of a particular apparatus carrying out the types of techniques described herein. It should also be appreciated that, unless otherwise indicated herein, the particular sequence of steps and/or acts described in each flowchart is merely illustrative of the algorithms that can be implemented and can be varied in implementations and embodiments of the principles described herein.

Accordingly, in some embodiments, the techniques described herein can be embodied in computer-executable instructions implemented as software, including as application software, system software, firmware, middleware, embedded code, or any other suitable type of software. Such computer-executable instructions can be written using any of a number of suitable programming languages and/or programming or scripting tools, and also can be compiled as executable machine language code or intermediate code that is executed on a framework or virtual machine.

When techniques described herein are embodied as computer-executable instructions, these computer-executable instructions can be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility can be a portion of or an entire software element. For example, a functional facility can be implemented as a function of a process, or as a discrete process, or as any other suitable unit of processing. If techniques described herein are implemented as multiple functional facilities, each functional facility can be implemented in its own way; all need not be implemented the same way. Additionally, these functional facilities can be executed in parallel and/or serially, as appropriate, and can pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities can be combined or distributed as desired in the systems in which they operate. In some implementations, one or more functional facilities carrying out techniques herein can together form a complete software package. These functional facilities can, in alternative embodiments, be adapted to interact with other, unrelated functional facilities and/or processes, to implement a software program application. In other implementations, the functional facilities can be adapted to interact with other functional facilities in such a way as form an operating system, including the Windows® operating system, available from the Microsoft® Corporation of Redmond, Washington. In other words, in some implementations, the functional facilities can be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that can implement the exemplary techniques described herein, and that embodiments are not limited to being implemented in any specific number, division, or type of functional facilities. In some implementations, all functionality can be implemented in a single functional facility. It should also be appreciated that, in some implementations, some of the functional facilities described herein can be implemented together with or separately from others (i.e., as a single unit or separate units), or some of these functional facilities can be omitted.

Computer-executable instructions implementing the techniques described herein (when implemented as one or more functional facilities or in any other manner) can, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium can be implemented in any suitable manner, including as system memory, accelerator memory, and/or system memory of the computer system 402 of FIG. 4 or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that can be altered in some way during a process of creating the medium with embedded information, a process of recording information thereon, or any other process of encoding the medium with information. For example, a magnetization state of a portion of a physical structure of a computer-readable medium can be altered during a recording process.

In some, but not all, implementations in which the techniques can be embodied as computer-executable instructions, these instructions can be executed on one or more suitable computing device(s) operating in any suitable computer system, or one or more computing devices (or one or more processors of one or more computing devices) can be programmed to execute the computer-executable instructions. A computing device or processor can be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions can be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

Embodiments have been described where the techniques are implemented in circuitry and/or computer-executable instructions. It should be appreciated that some embodiments can be in the form of a method, of which at least one example has been provided. The acts performed as part of the method can be ordered in any suitable way. Accordingly, embodiments can be constructed in which acts are performed in an order different than illustrated, which can include performing some acts simultaneously, even though shown as sequential acts in illustrative embodiments.

Various aspects of the embodiments described above can be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment can be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Unless otherwise noted, the terms “connected to” and “coupled to” (and their derivatives), as used in the specification and claims, are to be construed as permitting both direct and indirect (i.e., via other elements or components) connection.

Unless otherwise noted, a first numeric value is “approximately” equal to a second numeric value if the first numeric value is within + 20%, + 10%, or + 5% of the second numeric value.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

1. An apparatus comprising:
a transmitter in communication with a receiver for data transmission over an interconnect link, each of the transmitter and the receiver comprising:
at least one circuit,
wherein the at least one circuit packages a header and a data payload into data packets for transmission to the other of the transmitter and the receiver,
wherein, responsive to a request from the transmitter or the receiver, the at least one circuit of the transmitter or the receiver encodes a first sequence number and a second sequence number into the header of the data packet for transmission to the other of the transmitter or the receiver.

2. The apparatus according to claim 1, wherein the data packet is a data flit.

3. The apparatus according to claim 1, wherein the first sequence number is a transmitter sequence number, and the second sequence number is a receiver sequence number.

4. The apparatus according to claim 3, wherein the first sequence number characterizes the data packet being transmitted.

5. The apparatus according to claim 4, wherein the first sequence number is at least one of a partial sequence number or a full sequence number, and
wherein the at least one circuit is configured to periodically send a data packet including the full sequence number in the header after a defined number of data packets including the partial sequence number in a respective header.

6. The apparatus according to claim 3, wherein the second sequence number characterizes a previously transmitted flit.

7. A system comprising:
a transmitter comprising:
a first circuit; and
a receiver in communicable connection with the transmitter for transmission of data over an interconnect link, the receiver comprising:
a second circuit,
wherein each of the first circuit and the second circuit packages a header and a data payload into a data packet for transmission to the other of the transmitter and the receiver,
wherein, responsive to receiving a request from the transmitter or the receiver, a corresponding one of the first circuit or the second circuit is configured to encode a first sequence number and a second sequence number into the header of the data packet for transmission to the other of the transmitter and the receiver.

8. The system according to claim 7, wherein the data packet is a data flit.

9. The system according to claim 7, wherein the first sequence number is a transmitter sequence number, and the second sequence number is a receiver sequence number.

10. The system according to claim 9, wherein the first sequence number characterizes the data packet being transmitted to the other of the transmitter and the receiver.

11. The system according to claim 10, wherein the first sequence number is at least one of a partial sequence number or a full sequence number, and
wherein the corresponding one of the first circuit or the second circuit is configured to periodically send a data packet including the full sequence number in the header after sending a defined number of data packets including the partial sequence number in a respective header, to enable the other of the transmitter and the receiver to infer the full sequence number from the partial sequence number.

12. The system according to claim 9, wherein the second sequence number characterizes a previously transmitted flit.

13. The system according to claim 9, wherein the request is a replay request or an acknowledgement command.

14. The system according to claim 13, wherein, responsive to receiving the data packet from the transmitter or the receiver, the other of the transmitter and the receiver is configured to accept a previously received data packet stored at a buffer based on the first sequence number in the header of the received data packet.

15. A method comprising:
receiving, by a first device, data for transmission to a second device, wherein the first device is in communicable connection to the second device to transmit data packets over an interconnect link;
assembling, by a circuit of the first device, a datagram including a header and a data payload; and
transmitting, by the first device, the datagram to the second device over the interconnect link;
wherein, responsive to a request from the second device, the circuit of the first device encodes a first sequence number and a second sequence number into the header of the datagram for transmission to the second device.

16. The method according to claim 15, wherein the datagram is a data flit.

17. The method according to claim 15, wherein the first sequence number is a transmitter sequence number characterizing a respective datagram being transmitted, and the second sequence number is a receiver sequence number characterizing a previously transmitted datagram.

18. The method according to claim 17, wherein the first sequence number is at least one of a partial sequence number or a full sequence number.

19. The method according to claim 18, wherein the method further comprising:
inferring, by the second device responsive to the first sequence number being the partial sequence number in the header, the full sequence number based on a previously received full sequence number; and
sending, by the second device responsive to failing to infer the full sequence number from the partial sequence number, a replay request datagram to the first device.

20. The method according to claim 19, wherein the method further comprising:
sending, by the first device, a first datagram including the full sequence number in the header at a first clock cycle;
sending, by the first device, a set of second datagrams including the partial sequence number in a respective header at a respective second clock cycles; and
sending, by the first device, a third datagram including the full sequence number in the header at a third clock cycle,
wherein the second device infers the full sequence number from the partial sequence number of a second datagram received during a second clock cycle based on the full sequence number of the first datagram,
wherein the set of second datagrams are a defined number of datagrams.
